(19) United States
(12) Patent Application Publication
(10) Pub. No.: US 2020/0270710 A1
(43) Pub. Date: Aug. 27, 2020

(54) SYSTEMS AND METHODS FOR PRESERVING NUTRIENTS DURING THE PRODUCTION OF SYRUPS AND POWDERS FROM SUGARCANE USING COLD TECHNOLOGY AND PRODUCTS CONTAINING THE SAME

(71) Applicant: Whole Cane, Inc., Bellingham, WA (US)

(72) Inventors: Jeremiah Ridenour, Bellingham, WA (US); Timothy Ridenour, Bellingham, WA (US)

(21) Appl. No.: 16/820,348

(22) Filed: Mar. 16, 2020

Related U.S. Application Data
(63) Continuation-in-part of application No. 15/944,664, filed on Apr. 3, 2018, now abandoned.
(60) Provisional application No. 62/484,724, filed on Apr. 12, 2017.

(51) Int. Cl. C13B 10/02; C13B 50/00; C13B 25/00

(52) U.S. Cl. CPC C13B 10/025; C13B 25/00; C13B 50/00

(57) ABSTRACT

Systems, apparatuses, and methods for producing and using a sugarcane syrup or powder. In one embodiment, the invention is directed to a system and associated processes for processing sugarcane using a cold processing pipeline in a manner that retains its natural nutritional value while producing a syrup or powder without significant separation of the natural nutrients or use of heat or synthetic chemicals.

### CROSS REFERENCE TO RELATED APPLICATIONS

This application is a continuation-in-part of application Ser. No. 15/944,664, filed Apr. 3, 2018, which claims the benefit of U.S. Provisional Application No. 62/484,724, filed Apr. 12, 2017 (now expired), which is incorporated by reference herein in its entirety (including the Appendix) for all purposes.

### BACKGROUND

Sweetening agents are used in a wide variety of products, typically to enhance the taste or functionality (for example, the viscosity) of the product. Such products include foods, candies, medicines, beverages, drugs, and the like. However, presently available sweetener choices derived from conventionally used feedstock, such as sugarcane (Saccharin officinarum L.), sugar beets, or corn which offer nothing except calories in terms of nutritional content, as they are primarily highly refined carbohydrates, including a significant percentage of inverted or reducing sugars, fructose and glucose, which presents potential health problems. Research suggests that the over-consumption of refined sugars is a strong factor in the growth of diabetes, obesity, and cardiovascular disease, among consumers. Both of these conditions are at epidemic or near epidemic proportions worldwide. For example, 9.4% of the US population has been diagnosed with such conditions/diseases (with 235,000 deaths per year attributed to these diseases). And each year, younger and younger people are diagnosed with type I and type II diabetes and obesity as they adopt the consumption habits of their parents.

This (near) epidemic is at least partially the result of the processing methods and standards used in commercial sugar production. These include heating, pasteurization, chemical stripping, bleaching, flocculation, and refining natural sugarcane juice to create the sweetening agents used in foods and beverages. These white sugars have little or no nutritional value and a relatively high glycemic index (GI). Note that fructose, a common sweetening agent also known as high fructose corn syrup (HFCS) has been identified as one of the most detrimental sugars for human consumption, as it does not trigger the insulin response and is one of the main factors that produces fat in the liver (and the consumption of HFCS is believed to be one of the main factors leading to obesity). In fact, research suggests that consumption of high-fructose corn syrup in beverages may play a role in the epidemic of obesity (George A Bray Samara Joy Nielsen Barry M Popkin, The American Journal of Clinical Nutrition, Volume 79, Issue 4, 1 Apr. 2004, Pages 537-543, https://doi.org/10.1093/ajcn/79.4.537, Published: 1 Apr. 2004).

For example, the conventional method of processing sugarcane to produce refined sugars leaves white cane sugar as pure sucrose containing anywhere from 40-90% reducing sugars (glucose and fructose) in a final product devoid of nutritional content. Instead, the naturally occurring, beneficial-to-human nutrition, antioxidants, minerals, vitamins, and enzymes are removed via heat and chemicals and accumulated as molasses, a by-product of the conventional process. Note that based on USDA (2016), molasses includes many beneficial macro and micronutrients, including Vitamin B complex, as well as trace minerals such as calcium, iron, magnesium, potassium, all of which are removed or chemically refined out of the white sugar products produced by conventional processing methods, as shown in the table below:

| | | Value |
|---|---|---|
| | Unit | per 100 g |
| Nutrient | | |
| Water | g | 21.87 |
| Energy | kcal | 290.00 |
| Protein | g | 0.00 |
| Total Lipid | g | 0.10 |
| Carbohydrate, by | g | 74.73 |
| difference | | |
| Fiber, total dietary | g | 0.00 |
| Sugars, Total | g | 74.72 |
| Minerals | | |
| Calcium | mg | 205.00 |
| Iron | mg | 4.72 |
| Magnesium | mg | 242.00 |
| Phosphorus | mg | 31.00 |
| Potassium | mg | 1464.00 |
| Sodium | mg | 37.00 |
| Zinc | mg | 0.29 |
| Vitamins | | |
| Vitamin C, total | mg | 0.00 |
| ascorbic acid | | |
| Thiamin | mg | 0.0041 |
| Riboflavin | mg | 0.0020 |
| Niacin | mg | 0.9300 |
| Vitamin B-6 | mg | 0.6700 |
| Folate, DFE | μg | 0.00 |
| Vitamin B-12 | μg | 0.00 |
| Vitamin A, RAE | μg | 0.00 |
| Vitamin A, IU | IU | 0.00 |
| Vitamin E | mg | 0.00 |
| (alpha-tocopherol) | | |

USDA Standard Reference: Molasses (USDA, 2016)

As indicated by the table above, the molasses by-product from the conventional process contains a significant amount of nutrients which have been removed from the final refined white sugar product. Further, in conventional sugarcane processing, the processing steps that are applied are unable to preserve the majority of the polyphenol content (such as flavonoid and phenolic acids that function as beneficial antioxidants) due to an enzymatic browning reaction that begins to occur soon after the cane is harvested. Note that enzymatic browning is one of the major causes of deleterious changes in the sensory properties of the product, thereby limiting its storage for a longer time. Browning caused by polyphenol oxidize also causes other issues that may affect the antioxidant function of the product, due to it oxidizing the polyphenol content into O-Quinones that no longer have the molecular form that supports the anti-oxidant function. This is because when polyphenols are oxidized to form quinones, the reaction involved is a reversible reaction up to the stage of quinone development. However, if the oxidation process proceeds, it connects the individual phenol molecules between themselves and results in an oxidative condensation with the formation of polymeric products. At this later stage of molecular condensation, the antioxidant potential of the individual components is lost. The cold process pipeline address and solves this polyphenol breakdown allowing the antioxidant to remain functionally available to the end consumer.

Embodiments of the system and methods described herein are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems, apparatuses, and methods for producing and using a sugarcane syrup or powder. In one embodiment, the invention is directed to a system and associated processes for processing sugarcane in a manner that retains its natural nutritional value while producing a syrup or powder without significant separation or elimination of the natural nutrients. Further, the glycemic index (GI) of the resulting product or products achieves a low GI rating, a value which would provide significant benefits to those seeking a relatively lower GI replacement for refined sugar. In other embodiments, the processes described herein may be used to produce a product that can be used as a sweetening agent in multiple products or items.

The whole cane cold processing pipeline described herein does not separate any of the constituents of the sugarcane in its natural form leaving the valuable high nutrient molasses component in the final product.

The benefits and advantages of the embodiments described herein are achieved (at least in part) by a processing pipeline that operates below 40° C. (104° F.; i.e. lower temperature (or temperatures) than a conventional sugar processing pipeline) and does not use any harmful chemicals in the processing. To maintain the low temperatures necessary to retain maximum nutrients throughout the processing pipeline, in some embodiments, the inventive process includes the use of chilled water (or other coolant) circulating within a plate heat exchanger to maintain processing temperatures in the 2-4° C. range to avoid nutrient deterioration. The inventive process also uses a “cold” product protection and shelf life extending stage or processing step that is not reliant on heating the end product of the pipeline to destroy harmful bacteria (as would a conventional pasteurization processes). The resulting cane syrup or powder retains the majority of the nutritional value of the unprocessed sugarcane. In contrast to conventional processing pipelines for sugarcane, the cold process described herein leaves the nutrients unseparated, intact, and in their normal ratios to each other in the resulting syrup and powder. This act of leaving the natural nutritional composition intact and in its natural ratios impacts how body digests the complete nutritional spectrum contained in the whole cane juice, syrup and powder, and the human body treats it like a whole food rather than just pure concentrated sucrose (which spikes blood sugar and supports diabetic symptoms). Additional information regarding retention of bioactive compounds may be found in the paper entitled “The Effect of Extraction Temperature on Total Phenols and Antioxidant Activity of Gynura procumbens leaf.”

In some embodiments, the invention is directed to providing an industrial sweetener for use in consumer products and which does not result in a spike in blood sugar; such uses include coffee sweetener, ice cream, yogurts, soft drinks, sports drinks, pastries, chocolate, cereals, and the like. The composition of the sweetener provides specific nutrients such as iron, potassium, calcium, or magnesium, in sufficient quantities to be able to make label or health claims for the product to which the production of the system and processing methods described herein was added in the form of a syrup or powder.

In other embodiments, the invention is directed to the development of products from the base syrup and powder that can be used to replace pure sucrose in end products used in the pharmaceutical, medical, and cosmetic industries. These products include elixirs, cough syrups, medicated and non-medicated syrups, antioxidant rich cosmetics and foods targeted to individuals with chronic conditions, such as those that require nutrition in a sweetened format.

In one embodiment, the invention is directed to a method for processing sugarcane, where the method includes one or more of:
Processing the raw sugarcane within 24 hours of cutting;
Washing the sugarcane with water and an antimicrobial, chlorine, or hydrogen peroxide to minimize bacterial load and to remove field dirt and foreign materials;
Soaking the washed raw sugarcane in a first bio-acidifier solution prior to juicing to begin to minimize the antioxidant breakdown;
Juicing the soaked raw sugarcane sticks to produce raw cane juice;
Conditioning the sugarcane juice immediately after juicing, wherein the juice has a brix of less than or equal to 20 (including 13-15 brix, 15-18 brix, or 15-20 brix), to a pH of less than 4.5, including 3.5-4.2, by adding an amount of a second bio-acidifier solution to further prevent oxidation of antioxidants;
Passing the conditioned raw cane juice immediately through a cooling component to reduce the temperature of the raw cane juice to between 2 and 4° C. minimizing oxidation;
Subjecting the cooled raw cane juice to an evaporation step, wherein the evaporation step temperature is maintained below 40° C. until the brix value reaches a maximum value of 68; and,
Subjecting the production of the evaporation step to a process to prevent degradation from microbiological activity; and packaging the production of the cold product protection process.

In another embodiment, the invention is directed to a system for processing sugarcane, where the system may include one or more of:
A container for soaking the raw cane, the container including a first bio-acidifier solution;
A juicing element for juicing the soaked raw cane to produce raw cane juice;
A container for conditioning the pH of the raw cane juice, wherein the juice has a brix of less than or equal to 20 (including 13-15 brix, 15-18 brix, or 15-20 brix), to a pH of less than 4.5, including 3.5-4.2, by adding an amount of a second bio-acidifier solution;
A cooling element operative to reduce the temperature of the raw cane juice to between 2 and 4° C.;
An evaporator for subjecting the cooled raw cane juice to an evaporation process, wherein the evaporation process temperature is maintained below 40° C. until the brix value of the syrup reaches a maximum value of 68;
A processing element for protecting the production of the evaporator from degradation from microbiological activity; and
A packager for packing the production of the cold product protection process.

In general, embodiments of the system and methods described herein are directed to a cold processing pipeline for sugarcane without separation of sucrose and molasses, and the incorporation of the resulting “Whole Cane” syrup or powder into multiple products and delivery systems without any nutrient separation or removal. The resulting products are perceived by the human body as a “whole food” with its nutrients in their natural ratios to each other. These nutrients travel through the digestive systems, including the liver and kidneys which regulate blood sugar and blood pressure, thereby minimizing blood sugar spikes and providing nutraceutical quality nutrition.

Embodiments of the system and methods create nutritionally dense pharmaceutical or medical grade end products from a cold temperature non-chemical process pipeline operating below 40° C. that preserves the naturally occurring nutritional elements in the sugarcane plant without separation of sucrose from molasses components. This results in the production of a nutrient dense syrup or powder for applications in the medical, pharmaceutical, and cosmetic markets. The low temperature processing minimizes the development of detrimental reducing sugars, fructose and glucose. For example, normal white sugar and high fructose corn syrup (HFCS) processing can result in at least 40% development of reducing sugars, including up to 90% or more. However, in one example, the cold processing described herein results in reducing sugar development less than or equal to 10%. In other examples, reducing sugar development is less than or equal to 15%, 20%, 30%, 33%, or 35%.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1(a) is a diagram illustrating elements or components of a conventional processing system and pipeline for producing refined white sugar from raw sugarcane;

FIG. 1(b) is a diagram illustrating the types of products that may be derived from the conventional processing of sugarcane; and

FIG. 2 is a diagram illustrating elements or components of a system and pipeline for processing sugarcane in which an embodiment of the invention may be implemented.

FIG. 3 is a chart which indicates aspects or stages of the conventional cane processing pipeline at which deterioration may occur.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

As mentioned, embodiments of the sugarcane processing pipeline described herein may be used to produce a syrup or powder that retain much (if not all) of the nutritional value that is removed from refined sugar products that are produced using a conventional processing pipeline. Furthermore, besides the beneficial nutrients noted in the previous Table, the products of the process described herein (i.e., juice, syrup, and powder) also contain polyphenols, such as flavonoid and phenolic acid that function as antioxidants.

Based on a study titled “Antioxidant Activity in Sugarcane Juice and its Protective Role Against Radiation Induced DNA Damage”, 2007 Kadan, Ghosh, Straya De, Suprasanna, Devasagayam, Bapat, an ORAC test was conducted on three varieties of fresh sugarcane juice. The ORAC value of these 3 different varieties of sugarcane are shown in a table from the study, which is reproduced below. The study reveals that sugarcane juice has the ability to scavenge free radicals, reduce iron complex and inhibit lipid peroxidation, and explains possible mechanisms by which sugarcane juice exhibits its beneficial effects in relation to its reported health benefits.

Note that the study was conducted using cane juice that has yet to go through the processing pipeline described herein. After that processing, the inventor expects to find much higher ORAC levels due to the cold evaporation process, and acidification step which essentially concentrates the juice and raises the ORAC numbers reported above. In addition, because of the relatively low processing temperatures used, the inventor expects that most if not all of the original vitamins, minerals, antioxidants and other beneficial constituents will remain intact and beneficial while minimizing the production of harmful reducing sugars, fructose and glucose, to less than or equal to 10%. In one example, the reducing sugars are less than or equal to 6%, such as 5.03%. In other examples, reducing sugar development is less than or equal to 15%, 20%, 30%, 33%, or 35%.

It is noted that ORAC value is a quantitative method of measuring the antioxidant activity of plasma, foods, natural extracts, etc., and has become a standard, although not a method over the last five years. ORAC values, in micromole TE, Trolox (a soluble analogue of Vitamin E, used as a standard) equivalents per 100 g for cane syrup are shown in the Table below:

TABLE 1
Total phenolic and flavonoid content of sugarcane juice
and their antioxidant activities measured by ORAC assay

| | Total phenolic content | Total flavonoid content | ORAC value |
|---|---|---|---|
| Sugarcane juice | (mg GA eq/ml | (mg quercetin eq/ml | (μmol TE/ml |
| (varieties) | juice)^{a} | juice)^{a} | juice)^{b} |
| Co.C-419 | 631.5 ± 4.4 | 3.57 ± 0.03 | 16.35 |
| DSEM.Co.C-671 | 664.5 ± 3.9 | 4.88 ± 0.02 | 18.53 |
| Co.C-86032 | 402.3 ± 7.9 | 2.43 ± 0.04 | 23.64 |

GA eq- is gallic acid equivalent.
TE- is trolox equivalent.
^{a}Data expressed is mean ± standard error of four independent experiments.
^{b}Data expressed is of single experiment.

### Tracking the Traditional White Sugar and Molasses Process

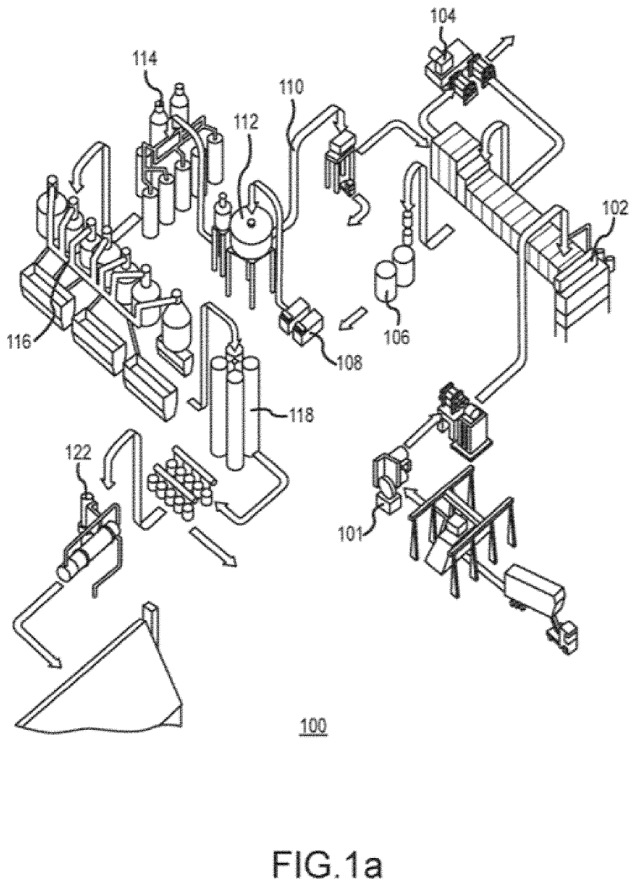

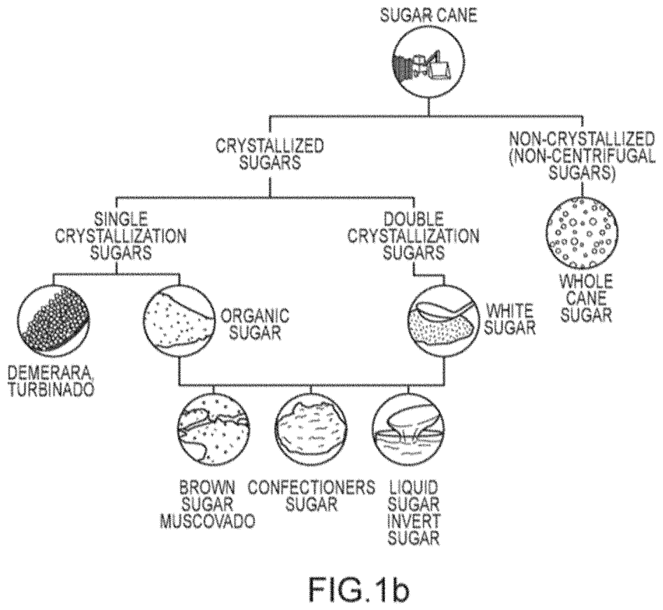

FIG. 1(a) is a diagram illustrating elements or components of a conventional processing system and pipeline 100 for producing refined white sugar from raw sugarcane. One or more chemicals used in the conventional processing can include, but are not limited to, chloride, chlorogenic acid, phosphates, phosphoric acid, carbonates, hydochloric acid, sodium hydroxide, tri-calcium phosphate, dimethyl ditallow, ammonium chloride, calcium hydroxide, polyacrylamide, the like, and combinations thereof. This set of processing steps or stages is typically used to produce a refined white sugar product. As shown or suggested by the figure, the raw sugarcane from the fields is cut, collected, shredded (as suggested by 101), and introduced into a cleaning element, such as the diffuser 102 illustrated in the figure. In conventional systems and processing methods, the cane may be subject to the formation of reducing sugars, such as glucose and fructose, due to the delay between the harvesting and processing, and the heat added during flocculation and pasteurization.

The diffuser 102 is used to clean raw cane coining from the field and is heated to 70-80° C. to remove field dirt and rocks, and to minimize bacteria. A dewatering mill or juicer 104 sends the juice back through the diffuser for re-heating before entering the juice weighing scale 106 in batches before going into the second heating phase, commonly termed “juice heating” 108. The cane juice is heated as flocculation chemicals, such as lime, bleaching agents or hydrolyzed polyacrylamides are added and organic sediments and insoluble minerals drop out of solution (i.e., they precipitate). These sediments and minerals, such as calcium or magnesium salts (which are unwanted in the refining process), drop out or flocculate and accumulate in what is termed “mill mud” 110 at the bottom of the juice-heating tank, where the flocculation process is performed at a temperature in the range of 80-100° C.

Sugarcane mill mud has a composition that may include organic carbon, nitrogen, phosphorus, potassium, calcium, magnesium, sulfur, copper, zinc, iron, and manganese. The mill mud composition, which is due to the flocculation step in the conventional processing pipeline. Further, mill mud has an acidic pH in the range of 4-4.9, and contributes to the BOD (biological oxygen demand) and COD (chemical oxygen demand) load in the wastewater. This is damaging to available water supplies and causes contamination (which may require chemicals to remediate the problem at the municipal level).

Note that mill mud has traditionally been applied to the surrounding sugarcane fields to provide some soil nutrition, although the procedure of spreading mill mud back on cane fields is really dumping a slurry-like material that the local processor has no use for. The volume of mill mud may be significant, and the mud typically contains trace minerals and unwanted chemicals. Note that due to the volume of material and newer analysis of this practice, mill mud is now viewed as a potential soil contaminate and source of ground water and stream pollution. Note also that embodiments of the cold processing pipeline described herein effectively eliminate the production of mill mud.

The process or component referred to as the “clarifier” 112 separates the mill mud and chemicals in a rotary filter and the clarified juice (which includes molasses) moves into the first evaporation stage 114. In making refined sugar, this evaporation is completed in double or triple effect evaporators with each one leading to the next evaporation step, which is set at a higher level of vacuum than the previous step. These evaporation temperatures range from 80-100° C. for prolonged periods. In a conventional processing workflow, the end goal at this stage is a brix level of 75-85 brix prior to entering the pan boiling station 116. This is where the product called golden syrup is pulled off (i.e., filtered out or otherwise removed). The golden syrup has a glycemic index of approximately 65, with the sugar content being approximately sucrose at 27%, and reducing sugars (comprised of glucose and fructose) of around 47%, with ash at 3% and water at 18%.

At this point in a conventional process, the syrup moves into a boiling pan evaporation phase 116 to increase brix and viscosity, before moving on to a crystallization phase 118, where crystallization begins to occur at 95+ brix. After a centrifugation phase 120 to remove the molasses, the crystals contain no or very few remaining nutrients and only sucrose, unless molasses is added back in to make light brown sugar. The crystalized sucrose is then subjected to another heating step 122 for purposes of drying the crystals to under 2% moisture, followed by cooling and conditioning to avoid clumping in the final package.

FIG. 1(b) is a diagram illustrating the types of products that may be derived from the conventional processing of sugarcane, such as the processing pipeline of FIG. 1(a). Note that each one of the refined products illustrated in the figure requires significant heating of the sweeteners (to above 100° C., which is boiling at normal atmospheric pressure) to facilitate chemical structural changes in the sugar composition during processing, and for drying before packaging. These heat treatments and their duration causes destruction of some of the nutrients, with the vitamins, enzymes, antioxidants and plant pigments being the most sensitive and typically being damaged or completely destroyed.

A product of the conventional processing pipeline called evaporated sugar or whole cane sugar, non-crystallized sugars are not put in a centrifuge and the molasses is not separated out of the mixture. Instead, the juice from crushed sugarcane stalks is heated and clarified using flocculation chemicals and the liquid is typically open-pan evaporated by boiling until the sugar spontaneously crystallizes at a high moisture content of 80-83+ brix. Usually this forms a solid block after cooling to room temperature in some sort of mold. The resulting sweetener, which retains all molasses and minerals, can be chipped off in chunks or ground into brown granules. Because of its high moisture and molasses content and affinity to absorb water, such whole cane sugars are typically not free flowing and are very difficult to handle in large, industrial-scale applications. For this reason, they are primarily sold in retail stores for direct consumption; examples include products sold or traded locally between villages or sold in traditional retail stores. These “wet” sugars are usually not produced under HACCP or inspected conditions. Depending on the country or place or manufacture, these products have names such as Raparua, Panella, Jaggery, and Moscavado and are not to be confused with the product produced by the cold system and methods described herein.

### The Cold Process Pipeline

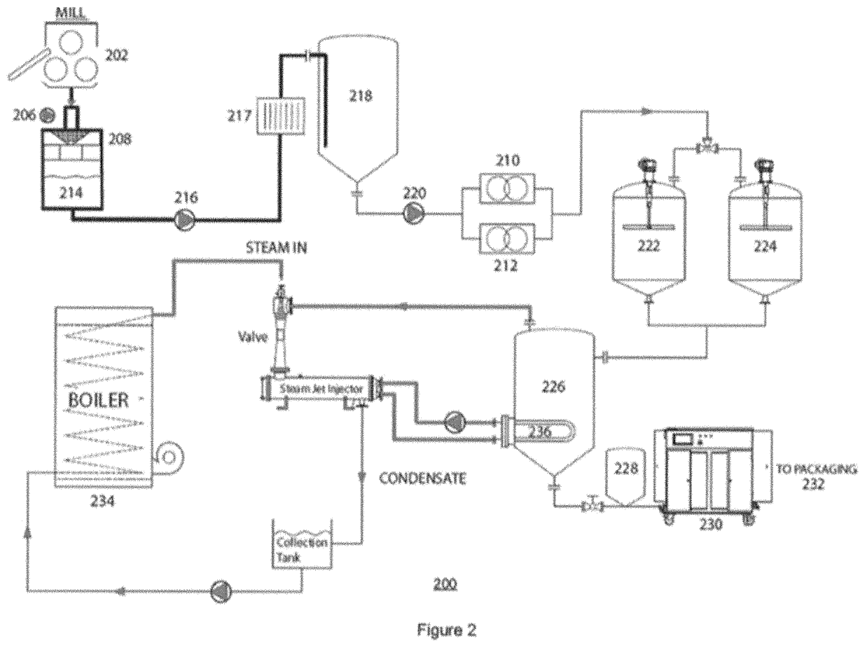

FIG. 2 is a diagram illustrating elements or components of a system and pipeline for processing sugarcane in which an embodiment of the invention may be implemented; more specifically, the figure illustrates the processing pipeline and elements or components of a cold processing system for processing sugarcane into a syrup having a maximum brix value of 68. The syrup can crystallize when the brix value is greater than 68 due to the lower reducing sugar content. The process is described below with reference to certain elements or components of FIG. 2:
a. Prior to juicing, the cut sugarcane is soaked in a solution of bio-acidifier (e.g., ascorbic acid, citric acid, lemon juice, lime juice, or other natural solution) for 2-4 hours at a concentration of 0.01-0.5% by weight to adjust its pH, which helps prevent enzymatic browning, development of polyphenoloxidase, and degradation of the natural antioxidants present in the sugarcane;
b. The cut raw sugarcane is washed in a pressure washer system with 200 ppm chlorine (or other organic approved biocide) to eliminate field dirt and foreign materials and inhibit bacterial growth;
c. The cane is juiced by being crushed between heavy rollers 202. In a separate process, the resulting bagasse (the fibrous material left over after juicing) is re-washed and re-crushed to remove residual juice—this can recover another 2-3% yield of dilute juice, brix 1-3, which may be added back into the process at the surge tank (note that the re-washing step or stage is not illustrated in the figure);
d. Peristaltic pump 206 delivers a 0.3-2.0% by weight concentration solution of the bio-acidifier (e.g., ascorbic acid, citric acid, lemon or lime juice, or other natural solution) immediately after juicing in order to control the pH and maintain it between 3.5 to 4.2, including 3.8-4.2, thereby minimizing the action of polyphenoloxidase and the destruction of antioxidants, and also preventing/minimizing enzymatic browning. The bioacidifier dosing may be performed/controlled using a continuous pH meter mounted in surge tank 214 that operates to control the peristaltic pump's delivery volume to ensure the same pH juice is entering the process. Examples of other natural buffers are addressed in Patents WO2008106755A1—Pereira Paulo Xavier, Nercio Jose & WO2017203494A1—Dipin KAPUR, Sachin Goel Neeraj Jalan 2016;
e. The juice then gravity feeds through a 250-micron filter 208 to filter out pieces of bagasse residue and to protect the downstream fine filters, components 210 and 212, from blinding-off prematurely and restricting flow;
f. The juice then accumulates into a jacketed surge tank 214 that has circulated chilled water running through its jacket attached to the cooling system to immediately begin to cool and protect the juice from chemical changes;
g. A positive displacement, vari-drive food grade pump component 216, pulls the rough juice coining from the surge tank 214 and pushes it through a plate heat exchanger 217 with food grade glycol circulating at −2 to −4° C. (25-28° F.) on one side of the stainless plates and cane juice on the other side of the plates (or other form of heat exchanger), to reduce the juice temperature from an estimated 25-30° C. down to 2-4° C.; this cooling slows fermentation and stabilizes/minimizes oxidation of the juice;
h. The balance tank 218 is fitted with high and low level controls, which turns off the juicing rollers 202 and the vari-drive pump 216 if there is a down-stream problem and juice backs up, or if the tank reaches the low threshold level, thereby ensuring no raw product overflows and that there is never an empty evaporator. These food grade, stainless level controllers are an electronic device or mechanism and may be chosen based on quality and price and set to generate both audible and/or electronic signal(s) which can page engineers on duty in case of a shutdown or out of specification malfunction;
i. Component 220, a positive displacement food grade vari-drive pump, provides juice from tank 218 to the fine filters 210 and 212, which are sized at 5-100 microns, depending on type of product that is ordered. These filters are used in an alternating manner so the process can continue while one unit is being cleaned. The filters remove smaller organic particles that could settle or float in the final packaging and be visibly undesirable during the post processing shelf life period;
j. After filtration, pump 220 pushes the juice into the cone bottom stainless, jacketed, 500 liter dosing tanks, components 222 and 224 in an alternating manner. These tanks are equipped with agitators for blending, and are jacketed and water-cooled; they serve as flavor or pH adjustment mixing tanks prior to evaporation. The raw juice may be pH adjusted prior to evaporation to standardize the juices; the tanks contain level controls to prevent overflow and running dry;
k. The juice then enters a low temperature (ranging between 35-40° C., including less than 40° C.) evaporation tank 226 less than or equal to 20 brix, including 13-15 brix, 15-18 brix, or 15-20 brix. When evaporation is performed below 40° C., it is possible to maintain most of the original attributes of the fresh pressed cane juice. For example, attributes retained or preserved during processing in this temperature range include phenols, amino acids, antioxidants, vitamins, minerals, and enzymes. Note that phenols and polyphenols, and antioxidants, along with vitamins C & B and enzymes, are the most unstable with regards to heat treatment;
l. For an evaporation process conducted below 40 degrees C., and operating under a pressure of 27.75 inches of Hg at 40° C., the resulting product is a syrup having a maximum brix value of 68. The evaporation process may be implemented using a boiler 234, coupled with a steam jet injector which assists in developing the needed vacuum, thereby reducing or eliminating the need for a more expensive liquid ring type vacuum pump, condensate collection tank for returning hot condensed water back to the boiler as pre-heated make up water (thereby reducing energy consumption), and associated pumps between boiler 234 and heating element 236;
m. After reaching the targeted brix level, up to 68 brix, the syrup is pumped into a 250 liter jacketed surge tank 228, prior to entering the cold product protection step, using equipment 230 (note that above 68 brix the syrup will crystalize during storage).
   Equipment 230 will be one or a combination of devices such as UV-C photo purification, HPP high pressure processing, PEF pulsed electrical field, microfiltration, or other device or process referred to herein. The optimal exposure time may be determined for the cold pasteurization equipment may be determined by testing the % reduction in bacteria, yeast and mold in final samples, with a target of a 5 log reduction being a goal. An example of suitable UV-C product protection equipment may be found in “Sterilization of Liquids Using Ultra-Violet Light” PCT ZA2000/000189, and EP1255444A2, and is specifically designed to be able to process opaque liquids, which was not possible prior to the development of that equipment. The correct circulating exposure time may be determined by allowing syrup to have variable exposure times depending upon Brix levels. The goal is to expose the syrups to photo purification or other cold method for as little time as possible to maintain all initial vitamins, minerals, antioxidants, amino acids, and enzyme concentrations, while minimizing yeast, mold, and bacteria, and thereby achieving a high standard of food safety without the use of high (and potentially damaging) heat or process chemicals.
n. A 68 brix syrup is placed in a pre-sterilized bag-in-box packaging 232 under aseptic conditions. The processing pipeline described herein should provide an estimated 12 to 18-month shelf life for the syrup;
   The syrup may be packaged into sterilized brown or green glass liters for retail applications, packed 10 to a box, 15-liter bag-in-box, or 1000-liter bag.
o. For dry powder production from syrup, the syrup is evaporated in the low temperature vacuum evaporator to 72-78 brix, then transferred to a low temperature vacuum belt dryer or spray drier, making a powder with a moisture content below 1.0% and which is not crystalized. Note that normal white sugar is crystalized using high temperatures between 120-125° C.

An important difference between a traditional refined white sugar/molasses production plant (such as that described with reference to FIG. 1(a)) and the “Whole Cane” nutraceutical syrup processing plant (such as that described with reference to FIG. 2) is the focus on preventing nutritional degradation and oxidation or fermentation of the cane-based syrup, while maintaining the natural ratio of nutrients occurring in the sugarcane itself. One advantage of this processing pipeline is to produce a nutraceutical syrup containing naturally occurring nutrients that are also sweet; this enables the syrup and products containing the syrup to provide a nutritional benefit while also acting as a sweetening agent having a low glycemic index (GI).

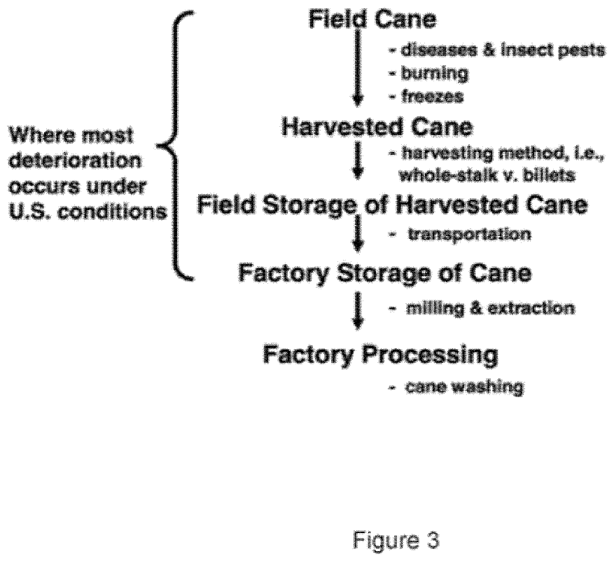

In some implementations, the system may utilize international manufacturing locations near to sugarcane growing fields to ensure freshness of raw materials. In some implementations, the system and processes include juicing and evaporating within 6-24 hours (or as soon as is practical) after cutting the cane to ensure a fresh juice that has not begun to significantly ferment, or oxidize, has minimized reducing sugar development (that is, glucose and fructose), and preventing off-flavors or compromised nutritional traits. FIG. 3 is a chart which indicates aspects of the conventional cane processing pipeline at which deterioration may occur. Note the indication of both the stage of the processing pipeline and the cause or causes of deterioration associated with that stage for each of the multiple stages.

Benefits, advantages, and aspects of embodiments of the system and methods described herein include one or more of the following:
a) a relatively low-to-medium glycemic index syrup, produced using non-traditional processing protocols that include maintaining processing temperatures below 40° C. in order to maximize the functionality of the natural nutrition in the sugarcane. In this regard, note that the GI separates carbohydrate-containing foods into three general categories:
   i. High Glycemic Index Foods (GI 70+) causing a rapid rise in blood-glucose levels;
   ii. Intermediate/Medium Glycemic Index Foods (GI 56-69) causing a medium rise in blood-glucose; and
   iii. Low Glycemic Index Foods (GI 55 or less) causing a slower rise in blood sugar.
b) a syrup that contains naturally occurring plant pigments (a source of beneficial nutrients);
c) a syrup containing naturally occurring nutrients in their native (or close to) ratios, including enzymes, vitamins, trace minerals, antioxidants and plant pigments. Note that sugarcane contains various phytochemicals including phenolic compounds, plant sterols, and policosanols;
d) a syrup using no processing chemicals aside from those used for natural pH adjustment (such as lemon or lime juice, ascorbic acid, citric acid, or other natural source);
e) a syrup that may be used as part of high-value applications and formulas, including (but not limited to) medical syrups, pharmaceutical low-to-medium GI applications, cosmeceutical, mediums to transport vitamins, minerals, cough syrups, elixirs, and use as a fermentation substrate for companies who prefer chemical-free or certified organic growing mediums;
f) a market focus on sourcing organic and/or sustainable grown cane;
g) to replace traditional refined cane syrup product uses in the medical field, or in medical or foods for diabetic consumers; and
h) utilizing one or more of UV-C photo purification, HPP high pressure processing), PEF (pulsed electrical field), or other device, chemical, process referred to herein to perform a cold (below 40° C.) pasteurization step, thereby eliminating spoilage organisms.

Note that by offering a nutrient-dense bacteriologically clean syrup or powder, the system and methods are capable of supplying a product into the medical, cosmetic and pharmaceutical fields; this product is provided in a familiar syrup or powder delivery system that contains significant nutrients and provides a potentially lower GI product depending on the formula, while delivering an acceptable sweet flavor (with roughly a 1-to-1 replacement ratio with respect to other sweetening syrups, which is an aspect that is highly desirable).

Possible product applications for the syrup and powder may include:
Low GI medical foods;
glucose delivery systems;
as a carrier for liquid vitamins, minerals, pre and probiotics taken orally;
cough syrup;
fermentation mediums for the production of enzymes, and biological substances;
beverages, candy/confectionary, cereal, coffee & vending;
condiments, sauces & dressing;
convenience foods;
dairy, yogurt, drinks;
fillings;
foods targeting diabetic consumers;
frozen ice cream and novelties;
gelatin, icing/glaze, jam/jelly, mixers;
snacks; and
cosmetics.

In addition to other benefits, embodiments of the low temperature process described herein produce a brix cane juice, a 68 brix cane syrup, and a dried powder that each have superior nutritional qualities over any refined or natural sweeteners. As realized by the inventor, the “cold” process described herein not only provides an improved sweetener or sweetening agent, but also a nutrient dense pharmaceutical syrup or powder for use in a number of applications or contexts, from food, to candy, to cosmetics, pharmaceuticals, to medicine.

Embodiments of the system and processing pipeline described herein eliminate the need for process chemicals and severe heat treatments, and may be used to produce (in some embodiments) a signature greenish colored syrup with the majority of nutrients naturally found in the cane plant (Saccharin officinarum L) still intact, highly bioavailable, and in their natural ratios to each other.

This cold process provides an alternative sweetener and a functional ingredient for use in applications where the manufacturer may want to increase the overall nutrient content for a manufactured food, thereby allowing them to make specific label health claims. As understood by the inventor, the described system and processing pipeline represent the first process that addresses the production of cold processed whole cane syrup without harsh chemicals, and provides an ability to maintain nutrient quality, quantity, good taste and odor.

In one embodiment, the process is organic. “Organic,” as defined by the USDA, means “(1) land must have had no prohibited substances applied to it for at least 3 years before the harvest of an organic crop; (2) soil fertility and crop nutrients will be managed through tillage and cultivation practices, crop rotations, and cover crops, supplemented with animal and crop waste materials and allowed synthetic materials; (3) crop pests, weeds, and diseases will be controlled primarily through management practices including physical, mechanical, and biological controls (when these practices are not sufficient, a biological, botanical, or synthetic substance approved for use on the National List may be used); (4) operations must use organic seeds and other planting stock when available; and (5) the use of genetic engineering, ionizing radiation and sewage sludge is prohibited.”

As noted, embodiments of the low temperature process described herein are intended to minimize nutrient damage by reducing processing temperatures in all phases below 40° C., and eliminating the use of the processing chemicals used in producing refined sugar. This approach preserves the nutritional value of a wide range of nutrients that are normally destroyed by the relatively high temperatures used in conventional processing pipelines. The result is to produce a nutraceutical product containing vitamins B1, B2, B3, B5, B6 minerals, iron, calcium, chromium, cobalt, copper, magnesium, manganese, phosphorous, potassium, and zinc, along with antioxidants including polyphenols such as Apigenis, Tricin, Luteolin, and Cinnamic acid in their respective amounts and proportions as would be found in raw sugarcane. The combination of low temperature processing, pretreatment of the cane (soaking in a bio-acidifier solution), the pH adjustment of the cane juice using a bio-acidifier (e.g., lime juice, lemon juice, ascorbic acid, citric acid, other natural solution, etc.), and the cold processing temperatures can also slow down the enzymatic browning reaction that is catalyzed by polyphenol oxidase (PPO) and peroxidase (POD).

Syrups are a concentrated solution of a sugar mixed in water or other aqueous liquid. In medical terminology, medicinal syrups or syrups are nearly saturated solutions of sugar in water in which medicinal substances or drugs are dissolved; basically, it is an oral suspension in liquid form where the medical syrup or pharmaceutical syrup is used as a vehicle for the delivery of medicine. It is usually used as a flavored vehicle for drugs. Syrups should be kept closed tightly in a cool, dry place after use in order to preserve them.

Medicinal syrups: widely consumed as children medicines, though medicated syrups for adults are also available. In general, there are various medicinal syrups such as cough syrups, iron syrups, calcium syrups, syrups for digestion, anti-allergy syrup, anti-fever syrup and so on that may benefit from use of the processing pipeline and its end products described herein. Some of the most popular medicated syrups are given in the list below; there are many medicines which are available in both tablet and syrup forms.
Ambroxol
Amoxicillin
Bromhexine
Cefpodoxime Proxetil
Cefixime
Cefadroxil
Cephalexin
Cefuroxime
Paracetamol
Chlorpheniramine Maleate
Dextromethorphan
Erythromycin
Ephedrine/Guaifenesin Syrup
Iron Tonic
Multivitamins
Cefaclor
Salbutamol
Cetirizine Hydrochloride
Protein Powder
Cloxacillin
Pseudoephedrine
Clarithromycin
Phenylephrine

Elixirs: A clear, sweetened, hydro-alcoholic liquid intended for oral use; elixirs contain flavoring substances and are used either as vehicles or for the therapeutic effect of the active medicinal agents.

Cosmetics: Polyphenols are plant compounds with high anti-oxidative activity making them attractive as ingredients for cosmetics. The chemical structure of polyphenolic compounds causes their reducing properties, which allow them to act as antioxidants and free radical scavengers.

### Nutritional Composition

The sugarcane syrup or powder produced by one or more of the methods or processes discussed herein can have the nutritional composition provided in the following table. This nutritional information is not intended to be limiting, but rather to provide an example of nutrients, vitamins, minerals, and the like retained by the cold processing techniques. The syrup or powder retains nutrients, vitamins, minerals, and the like in substantially the same proportions, ratios, amounts, or percentages as the raw sugarcane which undergoes processing to obtain the syrup or powder. In one example, the nutritional composition, whether proportions, ratios, amount, percentages, the like, or combinations thereof, varies by less than or equal to 10%, including less than or equal to 1%, less than or equal to 2%, less than or equal to 3%, less than or equal to 4%, less than or equal to 5%, less than or equal to 6%, less than or equal to 7%, less than or equal to 8%, less than or equal to 9%, less than or equal to 10%, up to 1%, up to 2%, up to 3%, up to 4%, up to 5%, up to 6%, up to 7%, up to 8%, and up to 9%. In another example, the nutritional composition, whether proportions, ratios, amount, percentages, the like, or combinations thereof, varies by less than or equal to 25%, less than or equal to 33%, or less than or equal to 50%. Furthermore, the variation of the nutritional composition can be different for different nutrients, vitamins, minerals, and the like. For example, Vitamin A in the syrup or powder may vary by 10% from the raw sugarcane, whereas Vitamin C in the syrup or powder may vary by 15% from the raw sugarcane. As another example, in raw sugarcane, Vitamin A to Vitamin D3 has a ratio of 10:1, and maintains that ratio in the sugarcane syrup or powder. Or, alternatively, Vitamin A to Vitamin D3 substantially maintains that ratio in the sugarcane syrup or powder varying by an amount or percentage as noted above.

As further shown in the table below, the development of reducing sugars (fructose and glucose) is 9.7%.

It should be further noted that the nutritional composition, such as that shown in the table below, is obtained without any nutrient, vitamin, or mineral additive to bring the nutritional composition to levels or amounts substantially equal or equivalent to the those of the raw sugarcane.

| | Amount | Units |
|---|---|---|
| Chemical | | |
| Ash | 0.7 | g/100 g |
| Proteins | 1.38 | g/100 g |
| Fat, total | 0.33 | g/100 g |
| Fatty acid composition | | |
| Trans fat in the fat | 3.71 | g/100 g |
| Saturated fat | 0.18 | g/100 g |
| Monounsatured fat | 0.11 | g/100 g |
| Polyunsaturated fat | 0.03 | g/100 g |
| Trans fat in the product | 0.01 | g/100 g |
| Sugar | | |
| Fructose | 4.8 | g/100 g |
| Glucose | 4.9 | g/100 g |
| Sucrose | 49.6 | g/100 g |
| Maltose | <0.5 | g/100 g |
| Lactose | <0.5 | g/100 g |
| Total Sugar | 59.3 | g/100 g |
| Vitamin A (Retinol) | <21 (LOQ) | ug/100 g |
| Vitamin C | 32.2 +/− 3.22 | mg/100 g |
| Vitamin D3 | <0.25 (LOQ) | ug/100 g |
| Copper | 0.3 +/− 0.1 | mg/kg |
| Iron | 3.0 +/− 0.7 | mg/kg |
| Chromium | <0.05 | mg/kg |
| Zinc | 3.2 +/− 0.8 | mg/kg |
| Manganese | 8.2 +/− 1.6 | mg/kg |
| Natrium | <0.01 | g/100 g |
| Potassium | 2600 +/− 520 | mg/kg |
| Magnesium | 540 +/− 110 | mg/kg |
| Calcium | 550 +/− 111 | mg/kg |
| Phosphorous | 150 +/− 30 | mg/kg |
| Selenium | <0.2 | mg/kg |
| Molybdenum | <0.1 | mg/kg |
| Iodine | <0.2 | mg/kg |
| Cholesterol | <2 | mg/100 g |

The following table shows antioxidant values for the syrup or powder. The cold processing techniques discussed herein prevents oxidation of polyphenoloxidase. If oxidation of polyphenoloxidase was to occur, such as in traditional processes, most, if not all, of the antioxidants' functionality would be destroyed.

| Analysis | Result | Units |
|---|---|---|
| ORAC against peroxyl radicals | 32.48 | μmole TE/gram |
| ORAC against hydroxyl radicals | 114.34 | μmole TE/gram |
| ORAC against peroxynitrite | 5.83 | μmole TE/gram |
| ORAC against super oxide anion | Not Detected | μmole TE/gram |
| ORAC against singlet oxygen | Not Detected | μmole TE/gram |
| ORAC against hypochlorite | 208.82 | μmole TE/gram |

There are six predominant reactive species found in the body: peroxyl radicals, hydroxyl radicals, peroxynitrite, super oxide anion, singlet oxygen and hypochlorite. ORAC 6.0 provides comprehensive analyses of antioxidant capacity of a food/nutrition product against the six predominant reactive species.
The ORAC result is expressed as micromole Trolox equivalency (μmole TE) per gram.

It is contemplated within the scope of the Whole Cane cold processing pipeline and its resulting products that the process and/or resulting products may be incorporated into various conventional pharmaceutical and cosmeceutical preparations and dosage forms, such as tablets (plain and coated) for use orally, bucally and sublingually, capsules (hard and soft, gelatin, with or without additional coatings), powders, granules (including effervescent granules), pellets, micro particulates, solutions (such as micellar, syrups, elixir and drops), lozenges, pastilles, ampoules, emulsions, micro emulsions, ointments, creams, suppositories, gels and transdermal patches, other transdermal delivery methods.

The present invention may also be impregnated, mixed, emulsified, sprayed or coated onto carriers such as cellulose, methylcellulose, dextrose, cyclodextrose, cyclodextrin, maltitol, fiber and fiber containing bioactives to improve delivery. Delivery may also be enhanced with a range of surfactants, lipids, complexes, solvents and co-solvents pharmaceutical delivery systems known in the pharmaceutical art to improve bioavailability, absorption and efficacy. For reference, see (1) Kannar, D and Kitchen, J. B. 2016. U.S. Pat. No. 9,364,016 B2, and (2) Zillich, O. V., Schweiggert-Weisz, U., Eisner, P. and Kerscher, M. 2015.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A method for processing raw sugarcane, comprising:
soaking the raw sugarcane in a first bio-acidifier solution;
juicing the soaked raw sugarcane to produce raw sugarcane juice;
conditioning the raw sugarcane juice by adding a second bio-acidifier solution;
reducing the temperature of the conditioned raw sugarcane juice by passing the conditioned raw sugarcane juice through a cooling component;
subjecting the cooled raw sugarcane juice to an evaporation step to produce a syrup, wherein the evaporation step temperature is maintained below 40° C. until the brix value reaches a maximum of 68 to avoid crystallization of the syrup; and
subjecting the produced syrup to a process performed at a temperature between 2 and 4° C. to prevent degradation from microbiological activity, prior to packaging.

2. The method of claim 1, wherein the first and second bio-acidifier solutions consist of lime juice, lemon juice, citric acid, or ascorbic acid.

3. The method of claim 1, wherein the raw sugarcane is soaked in the first bio-acidifier solution for a period of between 2 to 4 hours, and the first bio-acidifier solution comprises a concentration of between 0.01-0.5% by weight of the lime juice, lemon juice, citric acid, or ascorbic acid.

4. The method of claim 1, wherein the juicing of the soaked raw sugarcane is performed using a roller mill.

5. The method of claim 1, wherein the raw sugarcane juice is conditioned by adding the second bio-acidifier solution until the pH reaches a value between 3.5 and 4.2.

6. The method of claim 5, wherein the second bio-acidifier solution comprises a concentration of between 0.3 and 2% by weight of the lime juice, lemon juice, citric acid, or ascorbic acid.

7. The method of claim 1, wherein, during the reducing step, the temperature of the raw sugarcane juice is reduced to between 2 and 4° C.

8. The method of claim 1, wherein the cooling component is a heat exchanger.

9. The method of claim 1, further comprising performing, after the subjecting step and before packaging, one of UV photo purification, HPP high pressure processing, or PEF pulsed electrical field.

10. The method of claim 9, wherein the UV photo-purification includes UV-C radiation.

11. The method of claim 1, wherein subjecting the produced syrup step produces a final syrup.

12. The method of claim 11, the final syrup comprising a plurality of nutritional components, wherein each of the plurality of nutritional components decreases by less than or equal to 10% compared to the unprocessed raw sugarcane.

13. The method of claim 12, wherein the plurality of nutritional components in the final syrup include one or more of iron, calcium, magnesium, potassium, B-vitamins, trace minerals, enzymes, and antioxidants.

14. The method of claim 11, further comprising packaging the final syrup.

15. The method of claim 11, further comprising evaporating and drying the final syrup to a value of less than 2% moisture by weight as part of producing a dry powder.

16. The method of claim 15, wherein the evaporation and drying which produces the dry powder is performed by a low temperature vacuum belt dryer or spray dryer.

17. The method of claim 11, wherein the final syrup has less than or equal to 10% reducing sugars.

18. The method of claim 11, wherein the final syrup maintains antioxidant activity against peroxyl radicals, hydroxyl radicals, peroxynitrite, super oxide anion, singlet oxygen, hypochlorite, or combinations thereof.

19. The method of claim 1, wherein the raw sugarcane, the soaking step, the juicing step, the conditioning step, the evaporation step, or combinations thereof are processed by organic methods.

20. A final syrup processed from raw sugarcane produced by a process, the process comprising:
soaking the raw sugarcane in a first bio-acidifier solution;
juicing the soaked raw sugarcane to produce raw sugarcane juice;
conditioning the raw sugarcane juice by adding a second bio-acidifier solution;
reducing the temperature of the conditioned raw sugarcane juice by passing the conditioned raw sugarcane juice through a cooling component;
subjecting the cooled raw sugarcane juice to an evaporation step to produce a syrup, wherein the evaporation step temperature is maintained below 40° C. until the brix value reaches a maximum of 68 to avoid crystallization of the syrup; and
subjecting the produced syrup to a process performed at a temperature between 2 and 4° C. to prevent degradation from microbiological activity and produce the final syrup, prior to packaging.
wherein the final syrup has less than or equal to 10% reducing sugars and a maximum brix value of 68.

21. The final syrup of claim 20, comprising a plurality of nutritional components, wherein each of the plurality of nutritional components decreases by less than or equal to 10% compared to the unprocessed raw sugarcane.

22. The final syrup of claim 20, wherein the plurality of nutritional components comprise iron, calcium, magnesium, potassium, one or more B-vitamins, one or more trace minerals, one or more enzymes, one or more antioxidants, or combinations thereof.

23. The final syrup of claim 20, further comprising antioxidants that maintain activity against peroxyl radicals, hydroxyl radicals, peroxynitrite, super oxide anion, singlet oxygen, hypochlorite, or combinations thereof.

24. The final syrup of claim 20, further comprising a glycemic index of 55 or less.

25. The final syrup of claim 20, further comprising a plant pigment naturally occurring in the raw sugarcane.

26. The final syrup of claim 20, wherein the first and second bio-acidifier solutions consist of lime juice, lemon juice, citric acid, or ascorbic acid.

27. The final syrup of claim 20, wherein the raw sugarcane is soaked in the first bio-acidifier solution for a period of between 2 to 4 hours, and the first bio-acidifier solution comprises a concentration of between 0.01-0.5% by weight of the lime juice, lemon juice, citric acid, or ascorbic acid.

28. The final syrup of claim 20, wherein the raw sugarcane juice is conditioned by adding the second bio-acidifier solution until the pH reaches a value between 3.5 and 4.2.

29. The final syrup of claim 28, wherein the second bio-acidifier solution contains a concentration of between 0.3 and 2% by weight of the lime juice, lemon juice, citric acid, or ascorbic acid.

30. The final syrup of claim 20, wherein, during the reducing step, the temperature of the raw sugarcane juice is reduced to between 2 and 4° C.

31. The final syrup of claim 20, further comprising performing, after the subjecting step and before packaging, one of UV photo purification, HPP high pressure processing, or PEF pulsed electrical field.

32. The final syrup of claim 20, further comprising evaporating and drying the final syrup to a value of less than 2% moisture by weight as part of producing a dry powder.

33. The method of claim 20, wherein the raw sugarcane, the soaking step, the juicing step, the conditioning step, the reducing step, the first subjecting step, the second step, or combinations thereof are organic.
